(19) United States
(12) Patent Application Publication
(10) Pub. No.: US 2005/0135769 A1
(43) Pub. Date: Jun. 23, 2005

(54) Optical connector

(76) Inventors: Babak B. Makooi, Boca Raton, FL (US); Eric Nelson, Boca Raton, FL (US); Don D. Harlan, Wallington, FL (US); Earl Edwards, Lakeworth, FL (US); Arthur James Croone, Boyton Beach, FL (US); Guy A. Cole, Boca Raton, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/889,839

(22) Filed: Jul. 13, 2004

Related U.S. Application Data
(60) Provisional application No. 60/498,526, filed on Aug. 28, 2003.

(51) Int. Cl. G02B 6/00

(52) U.S. Cl. 385/135

(57) ABSTRACT

The present invention relates to optical connectors for use in circuit modules in which the reduction of electromagnetic interference is an objective. In particular, the cable connector of the present invention provides an EMI shielded connector housing for mounting and sealing to a module faceplate and a cover plate that seals the remaining open portions of the housing and provides for access to the inside of the assembled connector. At least one cable terminal is included within the connector and provides for an external cable connection axis between approximately 15° and 75° from a normal of said module faceplate.

This application claims priority from U.S. Provisional Patent Application Ser. No. 60/498,526, filed Aug. 28, 2003, the entire contents of which are incorporated by reference herein in its entirety.

### FIELD OF THE INVENTION

The present invention relates to optical connectors and, in particular, relates to optical connector assemblies for the placement of the same within modules and rack cards.

### BACKGROUND

It is well known that, in many electrical and electronic systems, due regard must be given to the shielding of components from electromagnetic interference (EMI). In opto-electronic systems, despite the apparent ruggedness of optical signals with respect to an EMI, EMI considerations need to be taken into account because of the electronics associated with the transmission and detection of light signals. For example, high speed synchronous optical network transport nodes are made up of many high speed electro-optical modules having electronic components operating at frequencies between 2.5 and 10 GHz or more. Each module will contain at least one printed circuit board (PCB). Each PCB is individually housed in a sealed enclosure thereby forming an EMI containment module. An electrically conductive bulkhead will extend from the front of each module and provide a shield for the module at the front, an enable the module to be secured to the shelf. Furthermore, third order, non-linear effects can affect the performance of not only the active components but also on the passive components. These considerations apply to other optical communications schemes.

Network equipment building system (NEBs) criteria levels have been drafted by Bellcore and other interested industrial bodies to provide a voluntary standard for industry players to determine the minimum EMI criteria and physical properties of components and systems for networks. In particular NEBS3 specifies certain electromagnetic compatibility levels and fire resistant requirements.

As another example, NEBS3 electromagnetic compliance requires telecommunications equipment to pass an open door emissions test with stringent limits. Most systems radiate sufficient electromagnetic energy to fail this test unless steps are taken to shield and ground the radiated energy. The level of required shielding will vary greatly depending on many variables of which aperture size (unshielded areas) and radiated frequency are two of the most significant. The ability of the design to minimize aperture size for plastic optical connectors is not easily accomplished especially when consideration is given to providing other features such as modularity, multiple choices for connector types and maintaining dense packaging and the like. Different systems have been designed according to NEBS3 requirements but none provide for a sufficiently protective enclosure at the circuit pack level. Accordingly, NEBS3 open door electromagnetic compatibility testing has not addressed such requirements. Hence, relatively large unshielded areas that reduce EMI shielding effectiveness have not been constructed to enable modularity and readily allow a variety of connector choices or allow easy access for servicing and maintenance of the optical fibre elements.

In electronic fields, printed circuit boards—each carrying electronic components and sometimes referred to as circuit packs, are mounted within shelves for connection at rear edges of the boards to other larger, interconnective circuit boards called backplanes. For this purpose, the backs are slideable into and out of fronts of the shelves in this manner.

As a general design consideration, circuit packs must also be shielded from external EMI as well as provide EMI protection generated by the circuit packs themselves. Accordingly, circuit packs are conventionally housed within EMI shields which may include a form of shielded housing surrounding the packs such that an EMI contained module is formed. It has also been found convenient, where EMI conditions allow, for two or more circuit packs to be retained within the same shielded housing. This shielded housing is then inserted into a receiving station within an electrical connection of the one or more circuit packs to the backplane.

In view of the trend for miniaturization of components, there is a need for compact enclosures into which optical fibre connectors fit securely and which prevent stray electronic EMI emissions.

### SUMMARY OF THE INVENTION

In accordance with a first aspect of the invention there is provided the fibre optic connector arrangement to an electromagnetic interference (EMI) shielded enclosure, wherein the EMI shielded enclosure has a front cover, wherein the fibre optic connector comprises at least one fibre optic terminal, wherein the fibre optic terminal has an axis to accept an input fibre optic cable along such axis, wherein the axis of these fibre optic terminals is approximately between 15° and 75° to a normal with the front cover, and wherein the EMI enclosure provides an output port through which fibre optic pigtails can exit the enclosure.

Where there are a number of terminals, each terminal is preferably arranged such that the terminal connectors arranged closely spaced together to maximize the use of internal space within the EMI shielded enclosure. Conveniently, the front cover of the enclosure has apertures adapted to accept standard fibre optic terminals with or without specific adaptors. Conveniently, the EMI shielded enclosure comprises a general rhomboid configuration whereby the optical connectors have an axis which is generally parallel with the sides of the rhomboid configuration. Conveniently, the rhomboid may be truncated whereby to provide an output passage for optic fibre without causing fibres therein to bend beyond specified limits. A generally cylindrical piece surrounding the fibres beyond the output aperture may be attached to this truncated section whereby to afford greater electromagnetic emission control.

A faceplate of the enclosure may be integrally fabricated with the faceplate of a module the enclosure of a generally rectilinear or rhomboid shape with sides of the enclosure being cut by side front and rear side plates. Alternatively, the enclosure may be provided by two clam-like shells. In this case any particular components will be of conductive material and a conductive gasket will be applied between any two components.

### BRIEF DESCRIPTION OF THE FIGURES

For a better understanding of the invention, there will now be described, by way of example only, specific embodiments according to the present invention with reference to the accompanying figures as shown in the accompanying drawing sheets, wherein:

FIG. 1 shows a particular embodiment of a multi module rack system;

FIG. 2 shows a cut-away view of a particular embodiment of a rack system with one module;

FIG. 3 shows a general view of an embodiment of the present invention;

FIG. 4 shows the embodiment shown in FIG. 3 with a side cover removed;

FIG. 5 shows an embodiment of the present invention with the components thereof in a spaced apart relationship; and

FIGS. 6a and 6b show a second embodiment of the invention.

### DETAILED DESCRIPTION OF THE INVENTION

There will now be described, by way of example, the best mode contemplated by the inventor for carrying out the invention. In the following description, numerous specific details are set forth in order to provide a thorough understanding of the present invention. It will be apparent, however, to one skilled in the art, that the present invention may be practiced by various other methods and apparatus. In other instances, well known methods and structures have not been described in detail so as not to obscure the central concepts of the present invention.

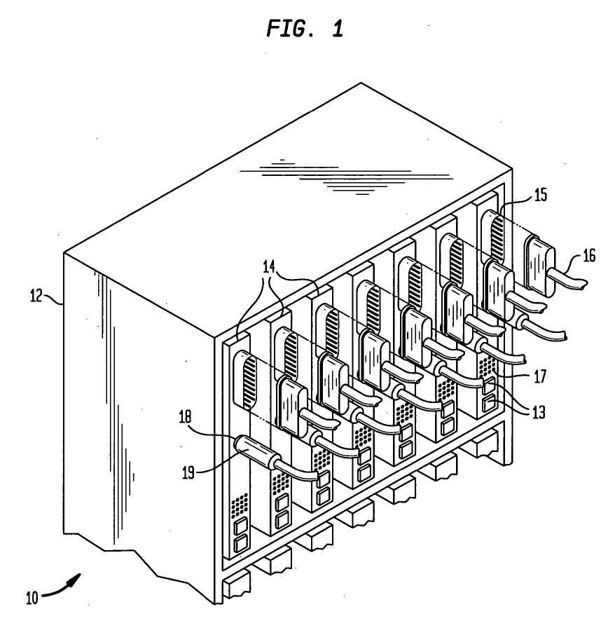

Referring now to FIG. 1 there is shown a multi module rack system 10 comprising an external cabinet 12 having modules 14 located in sub enclosures. On the face of each module there are shown switches 13, electrical cable connectors 15 attached to a cable terminator 16, indicator light 17 and fibre optic cable connectors 18 attached to fibre terminator 19 at the end of a fiber. In typical installations EMI shielding will be provided, for example, by providing sealant between the modules and/or through very closely fitting modules so as to ensure that any electromagnetic/optical emissions that stray from a module or an associated connector do not interfere with any other components.

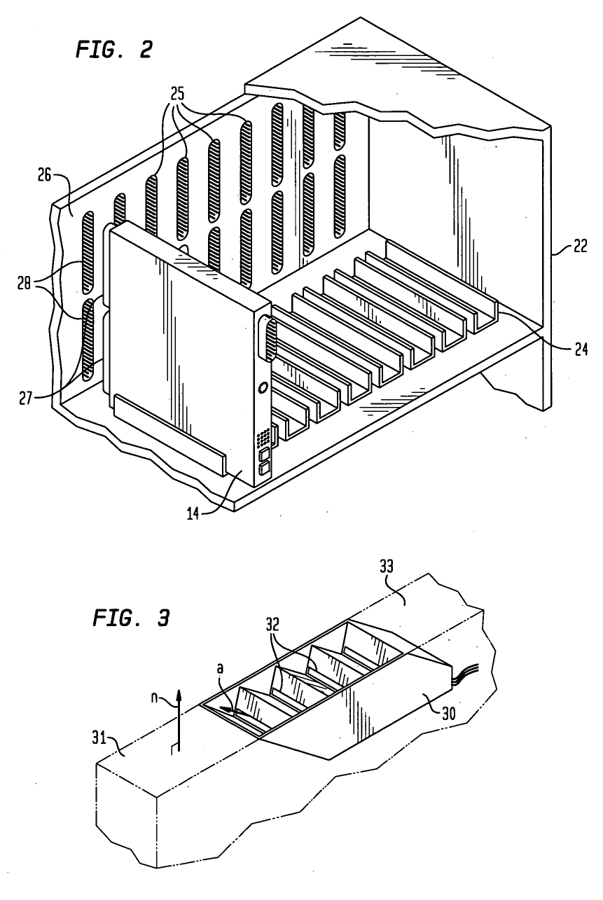

FIG. 2 shows a cut away view of cabinet 22 with tracks 24 and associated connectors 25 fixed upon a backplane 26. The cabinet has a single module 14 upon its associated track (not visible). The module connectors 27 are spaced from corresponding backplane connectors 28.

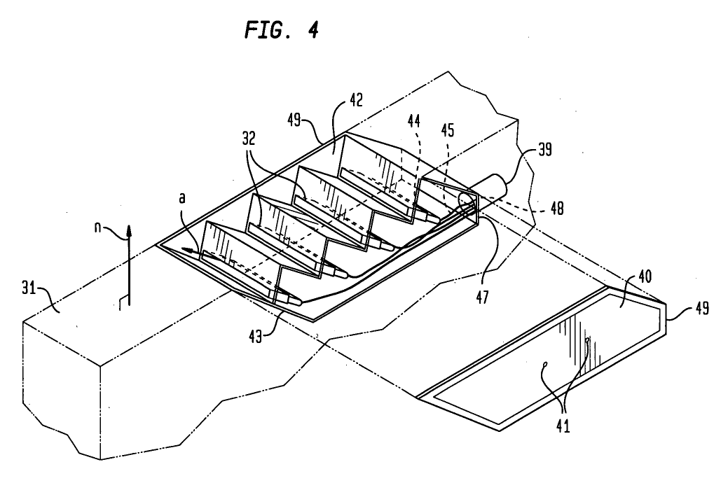

Referring now to FIG. 3, there is shown an optical connector housing 30 in accordance with the invention situated in a faceplate 31 of a module 14 indicated in dotted lines. Optical cable terminators 32 are shown with a connection axis, along which an external fibre optic cable is connected to the cable terminator. Each of the connectors is inclined with respect to a normal, n, of the faceplate. Typically, the orientation of the connection axis will be approximately 45°, although a range of angles including about approximately 15° to 75° are contemplated by the present invention. The selection of an appropriate connection axis will depend on different module design criteria, including but not limited to the type and construction of the cable to be connected and the number of connections that need to be made within each housing (i.e. the connection density). Further, the housing profile shown in FIG. 3 is generally rhombic whereby fibre tails (or pigtails, see FIG. 4, below) may lie in a generally parallel and closely spaced arrangement. This is in contrast to conventional connectors that are typically arranged such that they have an axis parallel with the normal associated with the module faceplate. The face of the housing 30 is generally stepped whereby the optical terminator 32 maximizes the use of available space. It should be appreciated that optical terminator 32 could extend beyond faceplate surface 33 to further maximize the use of space within the module.

FIG. 4 shows the optical connector housing comprised of housing 43, which is generally rhomboid in its cross-sectional shape and having side covers 40, 42 (removed). Each terminator 32 has a body portion 44 extending from the front (faceplate) and from which a fibre tail 45 extends. Housing 43 slants upward to region 47, where the fibre tails exit the housing/enclosure at aperture 48. In one particularly preferred embodiment, a metallic grounding cylinder 39 extends from the housing at region 37 to further reduce the propagation of stray electromagnetic emissions from the enclosure. Complimentary-wise, conductive foam or similar material is arranged about the fibres to achieve the same effect.

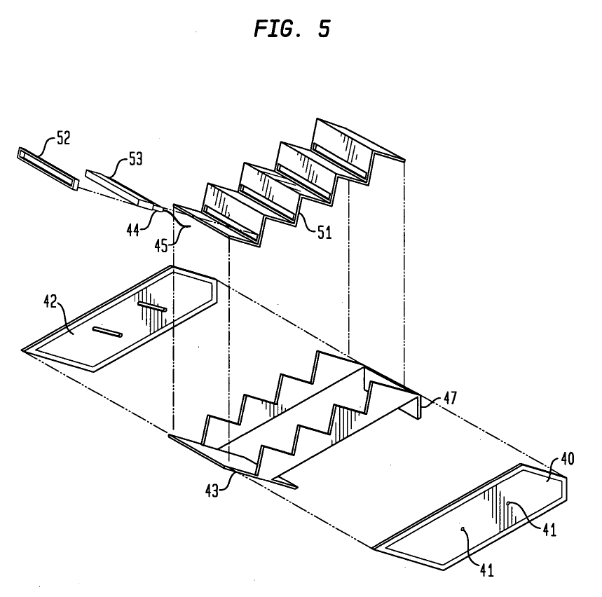

The optical connector housing 30 is also arranged to prevent emissions from inside the module radiating to the exterior of the module through the use of conductive gaskets 49 between the contacting edges of the connector housing and the front face of the faceplate, indicated in outline format by reference numeral 31. Conveniently, the side plates 40, 42 have depressions positioned to accommodate gasket 49 and to assist with both the seating of the gasket 49 and the addition of overall strength to the optical connection housing. With reference to FIG. 5, apertures 41 are positioned to enable a screw threaded retaining means or similar conductive fastening member to secure the side plates to the housing 43. Tabs (not shown) placed on the faceplate may be employed to ensure that the side plates fit securely and provide a sufficient biasing force against the gaskets towards the faceplate.

In one particular embodiment of the invention, the optical housing connector 30 is mounted to a module faceplate and has connector adaptors that are mounted to the fibre optic connector housing. Examples of appropriate adaptors include types such as LC, SL, FC, DIN or E2000, the appropriate selection of which is dependent upon the particular design needs and/or applicable standard to be followed. Note that the faceplate of the module could be an integral cast portion of the faceplate of the enclosure. The fibre optic connectors for the circuit pack (referred to as an optical fibre pigtails) are subsequently plugged into the body of the connector adaptors. The generally rhomboid enclosure is then fixed to the faceplate with the side plates fastened thereto. The fully assembled enclosure, including the conductive gaskets and the extension of the pigtail through aperture 48, provides an enclosure with a high level of both EMI shielding and fire resistance. The conductive gaskets are compressed after fastening the side plates to the rhomboid section and effectively form an aperture free, low resistance ground path. Preferably, there is an overlap of at least 5 mm. between each of the component parts of the module to help ensure such EMC control and, further to provide appropriate structural strength. Dimpling (not shown) formed in the side shields can assist in maintenance of the fastening hardware within the width of the faceplate. It will be appreciated that the assembly of the housing in this fashion enables the fibre to be inspected before enclosing the same.

Referring to FIG. 5, a simplified view of the side plates 40, 42 is shown with respect to the sides of generally rhomboid-shaped piece 43. Reference numeral 51 denotes a fibre optic panel into which an LC adaptor 52 snaps to fit. Those of skill in the art will appreciate that other connector and adapter types may be used with the present invention. In turn, LC connector adaptor 53 snaps to adaptor 52. Although the generally rhomboid-shaped side profile of housing 43 is not mandatory, it will be appreciated that this structure helps to reduce wasted space in a very small enclosure.

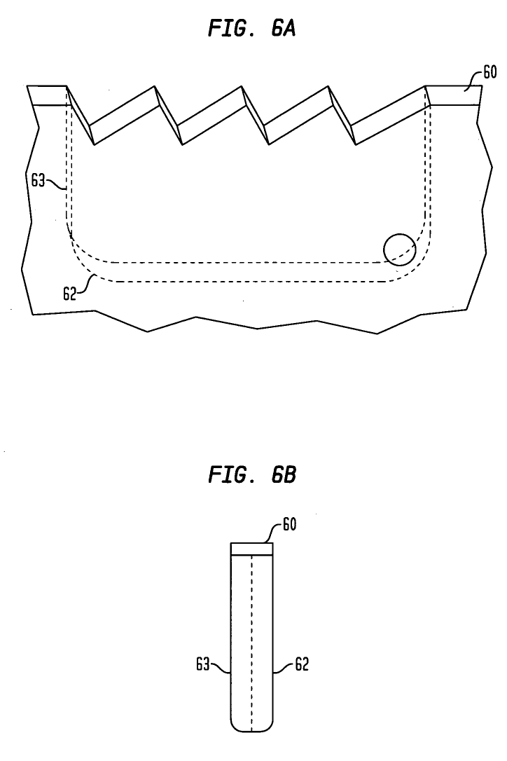

FIGS. 6a and 6b show a further embodiment of the optical connector according to the present invention. As shown in FIG. 6a, the enclosure comprises a faceplate 60 and two interlocking side shells 62 and 63. A conductive seal is preferably provided between part 62, 63 and 60, and a further conductive seal is preferably provided between part 62 and 63. The enclosure faceplate 60 may also comprise a part of the faceplate of the module. Although the enclosure shown on FIGS. 6a and 6b comprises a generally rectilinear enclosure, this enclosure is only shown as an example of one of several possible configurations. Additional embodiments might include a tray and lid combination or any other multiple-pieced assembly that provides for a fibre optic terminal enclosure.

The assembly process may be reversed if there is a need to service or upgrade the optical fibres. The side plates are removed by unfastening the screws, after which, any selected parts may be detached.

The present invention thus provides a configurable modularity. For example, the housing may be constructed to be half the thickness of a single module such that multiples may be placed side-by-side as well as atop one another. The modules of the present invention also allows for a more efficient use of the limited space available within a module through the use of fibre optic terminals disposed at an angle between approximately 15° and 75° to the normal of the faceplate, thereby permitting the connectors to be placed more closely together. However, the determination of an optimal angle is often a matter of various physical design considerations, possibly including ergodynamic factors. In particular, if a front cabinet cover is used to enclose the entire rack system and modules, then there will be a clearance distance between the module face plates and that front cabinet cover. In this scenario, the maximum acceptable bend radius of the externally attached fiber optic cables may dictate a minimum angle of the inclination of the fiber optic terminals. Similarly, a technician's finger size and/or access angle to the fiber optic connectors (either from the outside or inside of the module) may dictate a particularly advantageous angle for positioning the fiber optic terminals.

It is anticipated that a 45° angle will most likely be employed for typical situations, but reasonable variations will be employed to enable the most efficient use of space within any particular configuration. Using the chosen arrangements, the depth of the housings may be significantly reduced relative to what is known in the art, thereby permitting a closer packing of the optical terminal bodies (where a plurality of optical terminals are involved). Thus, high density, thin, tightly pitched circuit packs may be constructed to be not significant larger than a normal space occupied by connectors and fibre. The invention of the present invention has been designed to accommodate 57 and 27.5 mm pitch circuit packs, although in practice, smaller pitch circuit packs are possible. Similarly, angle of approximately 35° has been used to accommodate a 25 mm clearance between a front cabinet cover and the module face plates. Due to its modular construction and attachment, the present invention is compatible with a wide variety of faceplate manufacturing methods, including extrusion machining, welding, etc. Of course, the fibre optic terminators may include male or female receptacles so as to be coordinatively coupled to any fibre optic cable input to the module. The integration of optical connector mounting with custom modular metal enclosure provides a high degree of electromagnetic shielding effectiveness, fire resistance, and optional fibre routing control, while maintaining a flexible and an easy accessed optical interface.

While the present invention has been described in the context of a specific example, it shall be appreciated that the invention is not so limited to a single example, but that similar embodiments and variations are within the scope of the invention. For example, the invention encompasses not only optical connectors, but any connectors within a circuit module.

1. An EMI shielded cable connector comprising:
a housing for mounting to a module faceplate;
at least one cover plate for sealing said housing to form said connector and providing for access to the inside of the assembled connector;
at least one cable terminal having an external cable connection axis and disposed within said inside of said fully assembled connector; said external cable connection axis being disposed between approximately 15° and 75° from a normal of said module faceplate.

2. The cable connector of claim 1 wherein said cable connector is designed to house fiber optic cables and said cable terminal is a fiber optic cable terminal.

3. The cable connector of claim 1 wherein said cable connector further includes a port and cables from said module enter said cable connector through said port for connection to said cable terminal.

4. The cable connector of claim 3 wherein a cross section of said housing is generally rhomboid-shaped and said cables from said module are generally parallel with said cover plate.

5. The cable connector of claim 1 including a plurality of cable terminals, said terminal connectors arranged in a closely spaced arrangement.

6. The cable connector of claim 1 wherein said cable terminals include a standard type of fibre optic connectors.

7. The cable connector of claim 1 wherein said cable connector is disposed within a portion of a faceplate of an associated module.

8. The cable connector of claim 1 wherein said housing and said cover plate are substantially symmetrical.
